(19) United States
(12) Patent Application Publication
(10) Pub. No.: US 2021/0103299 A1
(43) Pub. Date: Apr. 8, 2021

(54) OBSTACLE AVOIDANCE METHOD AND DEVICE AND MOVABLE PLATFORM

(71) Applicant: SZ DJI TECHNOLOGY CO., LTD., Shenzhen (CN)

(72) Inventors: You ZHOU, Shenzhen (CN); Jiexi DU, Shenzhen (CN); Jie LIU, Shenzhen (CN)

(21) Appl. No.: 16/910,890

(22) Filed: Jun. 24, 2020

Related U.S. Application Data
(63) Continuation of application No. PCT/CN2017/120249, filed on Dec. 29, 2017.

(51) Int. Cl. G05D 1/10; G06T 7/246; G06T 7/269; G06T 7/73; G06T 7/50; G08G 5/04; G08G 5/00

(52) U.S. Cl. CPC G05D 1/106; G06T 7/248; G06T 7/269; G06T 7/73; G06T 2207/30244; G08G 5/04; G08G 5/0069; G06T 2207/30261; G06T 2207/10028; G06T 7/50

(57) ABSTRACT

An obstacle avoidance method includes obtaining a depth image photographed by a photographing device mounted at a movable platform, recognizing a moving object based on the depth image, determining a moving speed vector of the moving object, determining a potential collision region where the moving object is likely to collide with the movable platform based on the moving speed vector of the moving object; and controlling the movable platform to perform an obstacle avoidance process in the potential collision region.

### CROSS-REFERENCE TO RELATED APPLICATION

This application is a continuation of International Application No. PCT/CN2017/120249, filed on Dec. 29, 2017, the entire content of which is incorporated herein by reference.

### TECHNICAL FIELD

The present disclosure relates to the field of unmanned aerial vehicle (UAV) technology and, more particularly, to an obstacle avoidance method, an obstacle avoidance device, and a movable platform.

### BACKGROUND

With the increasing popularity of UAVs, more people are using UAVs for aerial photographing. However, it is a challenge for a user who never used a UAV before to operate the UAV. A minor operation mistake may cause a crashing accident. Thus, the user needs assistance in operating the UAV to avoid obstacles.

### SUMMARY

In accordance with the disclosure, there is provided an obstacle avoidance method including obtaining a depth image photographed by a photographing device mounted at a movable platform, recognizing a moving object based on the depth image, determining a moving speed vector of the moving object, determining a potential collision region where the moving object is likely to collide with the movable platform based on the moving speed vector of the moving object; and controlling the movable platform to perform an obstacle avoidance process in the potential collision region.

### BRIEF DESCRIPTION OF THE DRAWINGS

FIG. 1 is a flowchart of an obstacle avoidance method according to an example embodiment of the present disclosure.

FIG. 2 is a flowchart of a method for obtaining an optical flow vector of a target feature point according to an example embodiment of the present disclosure.

FIG. 3 is a flowchart of a method for recognizing a moving object according to an example embodiment of the present disclosure.

FIG. 4A is a schematic diagram illustrating optical flow vectors of target feature points according to an example embodiment of the present disclosure.

FIG. 4B is a schematic diagram illustrating clustering of the optical flow vectors in FIG. 4A.

FIG. 5 is a structural block diagram of an obstacle avoidance device according to an example embodiment of the present disclosure.

FIG. 6 is a structural block diagram of another obstacle avoidance device according to an example embodiment of the present disclosure.

### DETAILED DESCRIPTION OF THE EMBODIMENTS

Technical solutions of the present disclosure will be described with reference to the drawings. It will be appreciated that the described embodiments are some rather than all of the embodiments of the present disclosure. Other embodiments conceived by those having ordinary skills in the art on the basis of the described embodiments without inventive efforts should fall within the scope of the present disclosure.

When a first component is referred to as being “fixed” to a second component, the first component may be directly fixed to the second component or may have a third component between the first component and the second component. When the first component is referred to as being “connected” to the second component, the first component may be directedly connected to the second component or may have the third component between the first component and the second component. Unless otherwise defined, all technical and scientific terms used herein have the same meaning as commonly understood by those of ordinary skill in the art to the disclosure pertains. The terms used in the description of the present disclosure are for the purpose of describing particular embodiments of the present disclosure and are not intended to limit the present disclosure. The term “and/or” used herein includes any and all combinations of one or more of the associated listed items.

Technical solutions of the present disclosure will be described with reference to the drawings. The features described in the embodiments of the present disclosure may be combined with each other under a no-conflict condition.

In the existing technology, an obstacle avoidance process is often performed on movable platforms such as automobiles and unmanned aerial vehicles (UAV) in the following manners.

In one example, ultrasonic and infrared raging modules may be used. In this case, the operation is simple. When an object is detected, a braking action is performed. The braking action causes substantial noises to the detection, which in turn cause inadvertent braking actions. Further, the ranging only works for a short distance, and is completely useless when the movable platform is moving at a high speed.

In another example, a visual camera captures images and a machine vision algorithm is used to calculate depth images based on the captured images. For example, an RGB-D or a Time-of-Flight (ToF) module may be used to obtain the depth images. The obstacle avoidance process is performed based on the depth images. However, the depth images are calculated with a no-motion assumption, that is, it is assumed that objects in the captured images do not move relative to the Earth. For the movable platforms (e.g., UAVs) flying at a high altitude, the assumption generally holds true. However, for the moveable platforms hovering above the ground, the assumption generally does not hold true. It will be ineffective in avoiding automobiles or pedestrians.

Self-driving moveable platforms (e.g., self-driving cars) often perform the obstacle avoidance process based on Light Detection and Ranging (LiDAR) devices. However, LiDAR devices are costly and bulky.

To solve the above technical problems, the embodiments of the present disclosure provide an obstacle avoidance method. A photographing device mounted at a movable platform obtains depth images. Based on the depth images, a moving object is recognized and a moving speed vector of the moving object is determined. Based on the moving speed vector of the moving object, a region where the moving object may collide with the movable platform is determined, such that the movable platform is controlled to perform the obstacle avoidance process in the region of potential collision. In the present disclosure, the depth images are used to recognize the moving object. The movable platform is controlled to avoid the moving object, thereby improving the safety and user experience of the movable platform. The obstacle avoidance method according to the present disclosure is particularly effective in avoiding the moving objects, when the movable platform is a car moving on the ground or other movable object, or a UAV hovering above the ground.

Because the embodiments of the present disclosure involve depth image processing, for the convenience of understanding the technical solution of the present disclosure, certain parameters involved in the photographing device are described below. Taking a camera as an example, the camera model can be described using the following equation:

$$[ \begin{matrix}u \\ v \\ 1\end{matrix} ] = K [ R \vert T ] [ \begin{matrix}{x}_{w} \\ {y}_{w} \\ {z}_{w} \\ 1\end{matrix} ] ,$$

where R is a rotation matrix of the camera, [u v 1]^{T} represents two-dimensional (2D) points in pixel coordinates, [x_{w} y_{w} z_{w} 1]^{T} Represents Three-Dimensional (3D) Points in World coordinates, and matrix K is a camera calibration matrix (i.e., intrinsic parameters of the camera). For a finite projective camera, the matrix K includes five intrinsic parameters:

$$K = [ \begin{matrix}{α}_{x} & γ & {μ}_{0} \\ 0 & {α}_{y} & {v}_{0} \\ 0 & 0 & 1\end{matrix} ] ,$$

where aₓ=fmₓ, a_{y}=fm_{y}, f is a focal length, mₓ and m_{y} are scale factors (i.e., numbers of pixels in a unit distance) in x and y directions, respectively, γ is a skew parameter between x axis and y axis as pixels in a CCD camera are not square, and μ₀ and v₀ are principal points.

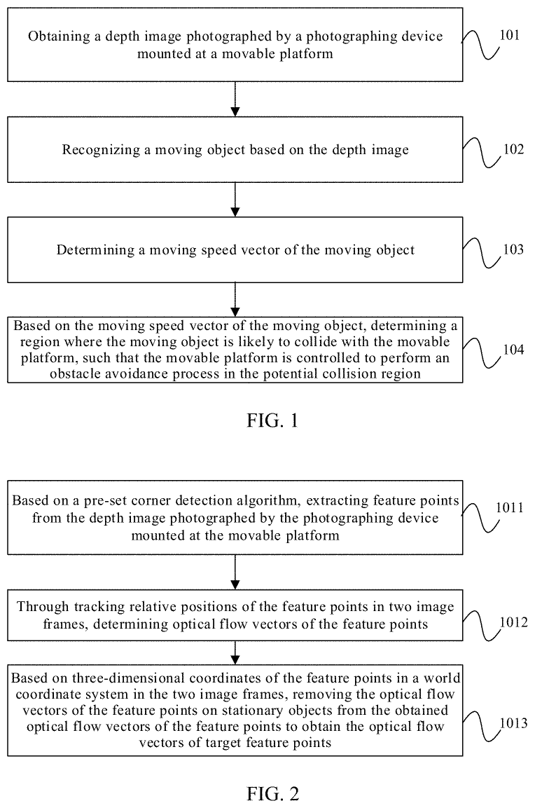

FIG. 1 is a flowchart of an obstacle avoidance method according to an example embodiment of the present disclosure. The method may be performed by an obstacle avoidance device. The obstacle avoidance device may be mounted at a movable platform or a ground terminal. As shown in FIG. 1, the method includes the following.

At 101, a depth image photographed by a photographing device mounted at a movable platform is obtained.

In some embodiments, the movable platform includes, but is not limited to, any one of an unmanned aerial vehicle, an automobile, VR glasses, and AR glasses.

In some embodiments, the photographing device includes at least one camera.

In some embodiments, two cameras separated by a pre-set distance simultaneously capture two images of a same scene. A 3D matching algorithm is used to process the two images to obtain the depth image. The example is intended to be illustrative and does not limit the present disclosure. The method for obtaining the depth image may include any one of methods in the existing technology and is not limited by the present disclosure.

At 102, a moving object is recognized based on the depth image.

In some embodiments, an optical flow vector of a target feature point in the depth image is obtained. The moving object is recognized based on the optical flow vector of the target feature point.

In some embodiments, the method for obtaining the optical flow vector of the target feature point includes at the least the following.

In one embodiment, because most objects in the photographed view are stationary and only a few objects are moving, the feature points on the stationary objects are the majority of all feature points on the photographed depth image while the feature points of the moving objects are the minority of all feature points on the photographed depth image. Directions of the optical flow vectors of the feature points of the moving objects are different from directions of the optical flow vectors of the feature points of the stationary objects. Thus, the optical flow vectors of the feature points of the moving objects are selected as the optical flow vectors of the target feature points by clustering the optical flow vectors of the feature points in the depth image.

In another embodiment, the optical flow vectors of the feature points of any objects other than the stationary objects (i.e., optical flow vectors of the target feature points) may be selected from the depth image photographed by the photographing device mounted at the movable platform through a visual odometry (VO) algorithm carried by the movable platform. FIG. 2 is a flowchart of a method for obtaining an optical flow vector of a target feature point according to an example embodiment of the present disclosure. As shown in FIG. 2, the method includes the following.

At 1011, feature points are extracted from the depth image photographed by the photographing device mounted at the movable platform according to a pre-set corner detection algorithm.

In some embodiments, to reduce the amount of calculation, a method for generating a sparse matrix is adopted to extract the feature points from the depth image photographed by the photographing device. Corners are selected from the depth image as the feature points without losing generality. The corner detection algorithm may include, but is not limited to, a features from accelerated segment test (FAST) algorithm, a smallest univalue segment assimilating nucleus (SUSAN) algorithm, or a Harris corner detection algorithm.

In one embodiment, the Harris corner detection algorithm is adopted as an example, and matrix A is defined as a structure tensor of the depth image:

$$A = {Σ}_{u} {Σ}_{v} w ( u , v ) [ \begin{matrix}{I}_{x}^{2} & {I}_{x} {I}_{y} \\ {I}_{x} {I}_{y} & {I}_{y}^{2}\end{matrix} ] = [ \begin{matrix}〈 {I}_{x}^{2} 〉 & 〈 {I}_{x} {I}_{y} 〉 \\ 〈 {I}_{x} {I}_{y} 〉 & 〈 {I}_{y}^{2} 〉\end{matrix} ] ,$$

where Iₓ and I_{y} are gradient information of a point of the depth image in x and y directions, respectively. Based on the matrix A, a corner point response value (M_{c}) of the point of the depth image is obtained:

M_{c}=λ₁λ₂−k(λ₁+λ₂)²=det(A)−ktrace²(A)

where det(A) is the determinant of the matrix A, trace (A) is the trace of the matrix A, and k is the tunable sensitivity parameter. A threshold Mₜₕ can be set, and when M_{c}>Mₜₕ, the corner point is determined to be a feature point.

At 1012, optical flow vectors of the feature points are determined through tracking relative positions of the feature points in two image frames.

In some embodiments, the relative positions of the obtained feature point in two or more image frames are tracked. Based on displacements of the relative positions of the feature point in two or more image frames, the optical flow vector of the feature point is determined. Taking two image frames as an example, after tracking the relative positions of the obtained feature point in the two image frames, the displacement h of the relative positions of the feature point in the two image frames is iteratively obtained according to the following equation:

$$\{ \begin{matrix}{h}_{0} = 0 \\ {h}_{k + 1} = {h}_{k} + \frac{{Σ}_{x} w ( x ) {F}^{′} ( x + {h}_{k} ) [ G ( x ) - F ( x + {h}_{k} ) ]}{{Σ}_{x} w ( x ) {{F}^{′} ( x + {h}_{k} )}^{2}}\end{matrix} .$$

For each feature point, the displacement is detected twice. In one detection, a succeeding image frame is set as F(x) and a preceding image frame is set as G(x). Based on the above equation, a first displacement h of the relative position of the feature point on the succeeding image frame relative to the relative position of the feature point on the preceding image frame is obtained. In another detection, the preceding image frame is set as F(x) and the succeeding image frame is set as G(x). A second displacement h′ of the relative position of the feature point on the preceding image frame relative to the relative position of the feature point on the succeeding image frame is obtained. If a relationship between the first displacement and the second displacement satisfies a first priori condition, the optical flow vector of the feature point is determined to be h. For example, the first priori condition may be, but is not limited to, h=−h′. In some embodiments, the first priori condition may also be h=−h′+a, where a is a pre-set error and is a constant.

The above embodiments are merely illustrative and not limiting the present disclosure. In practical applications, the displacement for each feature point may be determined only once. For the determination method thereof, reference can be made to the above embodiments and the details will not be repeated here.

At 1013, based on three-dimensional coordinates of the feature points in a world coordinate system in the two image frames, optical flow vectors of the feature points of stationary objects are removed from the obtained optical flow vectors of the feature points to obtain the optical flow vectors of the target feature points. That is, the remaining ones of the optical flow vectors are taken as the optical flow vectors of the target feature points.

In one embodiment, based on the three-dimensional coordinates of the feature point in the world coordinate system in the two image frames, the position and attitude of the photographing device when photographing the two image frames are determined. Based on the position and the attitude of the photographing device when photographing the two image frames, a random sampling consensus (RANSAC) algorithm is used to obtain the optical flow vectors of the feature points other than the feature points of the stationary objects. The algorithm can be described in the following equation:

$$s {p}_{c} = K [ R \vert T ] {p}_{w} , \\ s [ \begin{matrix}u \\ v \\ 1\end{matrix} ] = [ \begin{matrix}{f}_{x} & γ & {u}_{0} \\ 0 & {f}_{y} & {v}_{0} \\ 0 & 0 & 1\end{matrix} ] [ \begin{matrix}{r}_{11} & {r}_{12} & {r}_{13} & {t}_{1} \\ {r}_{21} & {r}_{22} & {r}_{23} & {t}_{2} \\ {r}_{31} & {r}_{32} & {r}_{33} & {t}_{3}\end{matrix} ] [ \begin{matrix}x \\ y \\ z \\ 1\end{matrix} ] ,$$

where R is a rotation matrix having the position and the attitude of the photographing device when photographing the image frames as the priori. p_{c} is the two-dimensional coordinates of the feature point in the depth image. p_{w} is the three-dimensional coordinates of the feature point in the world coordinate system.

In another embodiment, based on a pre-set second priori condition, an essential matrix corresponding to the three-dimensional coordinates of the feature points in the world coordinate system in the two image frames is determined. Based on the calculated essential matrix, the RANSAC algorithm is used to obtain the optical flow vectors of the feature points in the depth image other than the feature points of the stationary objects.

For example, assuming that the three-dimensional coordinates of the feature point in the world coordinate system in the two image frames are y and y′, respectively, the essential matrix E is determined based on the second priori condition by the following equation:

(y′)^{T}Ey=0

Further, the RANSAC algorithm is used to obtain the optical flow vectors of the feature points in the depth image other than the feature points of the stationary objects, that is, the optical flow vectors of the target feature points. The operation principle and execution process of the RANSAC algorithm may refer to the existing technology and will not be repeated here.

Further, after the optical flow vectors of the target feature points are obtained, based on the optical flow vectors of the target feature points, the depth information of the target feature points, and the visual information of the target feature points, the moving object is recognized. The visual information includes color and/or brightness.

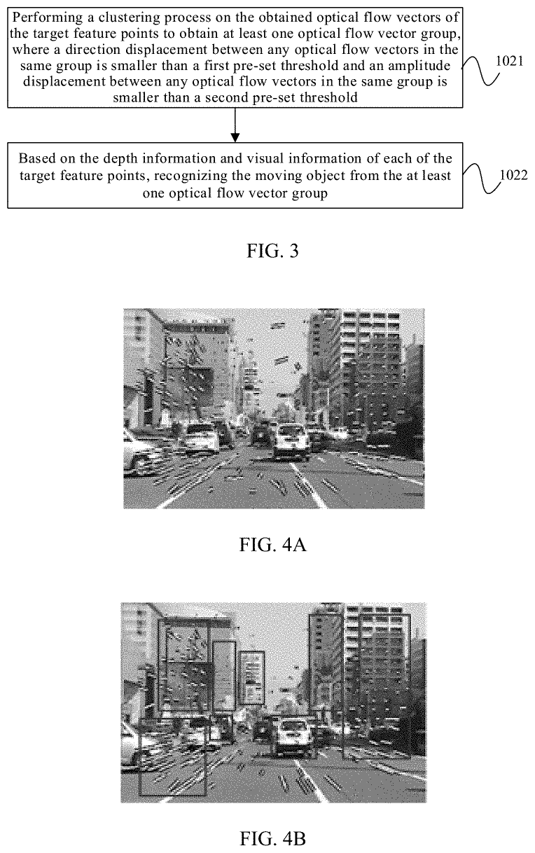

FIG. 3 is a flowchart of a method for recognizing a moving object according to an example embodiment of the present disclosure. As shown in FIG. 3, the method for recognizing the moving object includes the following.

At 1021, a clustering process is performed on the obtained optical flow vectors of the target feature points to obtain at least one optical flow vector group, where a direction displacement between any optical flow vectors in the same optical flow vector group is smaller than a first pre-set threshold (also referred to as a “direction threshold”), and an amplitude displacement between any optical flow vectors in the same optical flow vector group is smaller than a second pre-set threshold (also referred to as an “amplitude threshold”).

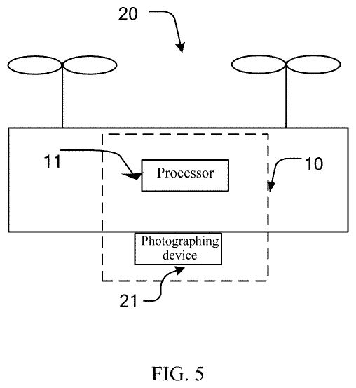

FIG. 4A is a schematic diagram illustrating optical flow vectors of target feature points according to an example embodiment of the present disclosure. The optical flow vectors in FIG. 4A can be expressed using Lucas-Kanade algorithm as follows:

$$[ \begin{matrix}{V}_{x} \\ {V}_{y}\end{matrix} ] = {[ \begin{matrix}{\sum }_{i} {{I}_{x} ( {q}_{i} )}^{2} & {\sum }_{i} {I}_{x} ( {q}_{i} ) {I}_{y} ( {q}_{i} ) \\ {\sum }_{i} {I}_{y} ( {q}_{i} ) {I}_{x} ( {q}_{i} ) & {\sum }_{i} {{I}_{y} ( {q}_{i} )}^{2}\end{matrix} ]}^{- 1} [ \begin{matrix}- {\sum }_{i} {I}_{x} ( {q}_{i} ) {I}_{t} ( {q}_{i} ) \\ - {\sum }_{i} {I}_{y} ( {q}_{i} ) {I}_{t} ( {q}_{i} )\end{matrix} ] ,$$

where qᵢ is a point in a field of point P of the depth image. The size of the field of point P may be configured according to actual needs, and is not limited by the present disclosure. For example, when the field of point P is a 5×5 field, the field of point P includes 25 points. The optical flow vector corresponding to qᵢ is [Vₓ V_{y}]^{T}, Iₓ and I_{y} are gradient information of point qᵢ of the depth image in x and y directions, respectively, and Iₜ is a brightness change of qᵢ between the two image frames.

In one embodiment, based on the above optical flow vector representation, a clustering algorithm (e.g., K-means++ algorithm) in unsupervised machine learning is used to perform the clustering process on the optical flow vectors of the target feature points. As such, the position [u v]^{T} of each of the target feature points in the depth image, the color and/or brightness of the target feature points, and the optical flow vectors [Vₓ V_{y}]^{T} are used in the clustering process to obtain at least one optical flow vector group in FIG. 4B. The clustered optical flow vector group can be expressed as follows:

[uvVₓV_{y}(u,v,t)]^{T}.

The above expression is merely illustrative and not a limitation of the present disclosure.

At 1022, based on depth information and visual information of each of the target feature points, the moving object is recognized from the at least one optical flow vector group.

In some embodiments, based on the depth information of each of the obtained target feature points and the color and/or brightness of each of the obtained feature points, a floodfill algorithm is used to recognize the moving object from at least one obtained optical flow vector group.

At 103, a moving speed vector of the moving object is determined.

In one embodiment, based on the three-dimensional coordinates of the moving object in the world coordinate system in the pre-set number of image frames, the moving speed vector of the moving object is determined.

At 104, based on the moving speed vector of the moving object, a region where the moving object may collide with the movable platform (also referred to as a “potential collision region”) is determined, such that the movable platform is controlled to perform the obstacle avoidance process in the potential collision region.

In some embodiments, based on the moving speed vector of the moving object and the moving speed vector of the movable platform, the following equations are used to determine a moving path of the movable platform, and based on the moving path of the movable platform, the region where the moving object may collide with the movable platform is determined:

$$[ \begin{matrix}x \\ y \\ z\end{matrix} ] = K [ {R}_{c w} \{ [ \begin{matrix}{x}_{w} \\ {y}_{w} \\ {z}_{w} \\ 1\end{matrix} ] + {V}_{object}^{w} \cdot Δ t + {T}_{w c} + {V}_{drone}^{w} \cdot Δ t \} ] , \\ [ \begin{matrix}u \\ v \\ 1\end{matrix} ] = z [ \begin{matrix}x / z \\ y / z \\ z / z\end{matrix} ] .$$

In some embodiments, after the moving path of the movable platform is obtained, the moving path of the movable platform is projected onto the depth image. Based on the moving path of the movable platform, the region where the moving object may collide with the movable platform is determined in the depth image. Based on the coordinate information of various regions of the depth image in the world coordinate system, the three-dimensional coordinates, in the world coordinate system, of the region where the moving object may collide with the movable platform are determined. As such, the movable platform is controlled to perform the pre-set obstacle avoidance process at the three-dimensional coordinates. For example, after the collision region is determined, the movable platform is controlled to move in a direction opposite to a current moving direction, or the moving path of the movable platform is adjusted to circumvent the potential collision region, or the movable platform is controlled to stop moving for a pre-set time period, thereby achieving the objective of obstacle avoidance. The embodiments are illustrative and do not limit the obstacle avoidance method of the present disclosure. In practical applications, the obstacle avoidance process is configured to satisfy actual needs.

In some embodiments, to increase the interaction between users and improve user experience, the moving path of the movable platform may be displayed, and the potential collision region may be displayed to notify the user to timely perform the obstacle avoidance process.

The present disclosure provides the method and the device for obstacle avoidance and the movable platform. The optical flow vectors of the target feature points in the depth image photographed by the photographing device mounted at the movable platform and the moving speed vector of the movable platform are obtained. Based on the obtained optical flow vectors of the target feature points, and the depth information and the visual information of the target feature points, the moving object is recognized from the depth image. Through tracking the three-dimensional coordinates of the moving object in the world coordinate system in the pre-set number of the image frames, the moving speed vector of the moving object is determined. As such, based on the moving speed vector of the moving object and the moving speed vector of the movable platform, the region where the moving object may collide with the movable platform is determined, and the movable platform is controlled to perform the obstacle avoidance process in the potential collision region.

In the embodiments of the present disclosure, the moving object is recognized and based on the moving speed vector of the moving object, the region where the moving object may collide with the movable platform is determined, such that the movable platform is controlled to avoid the moving object, and the safety and the user experience of the movable platform are improved. The obstacle avoidance method can in particular effectively prevents the moving object from affecting the movable platform when the movable platform is the car moving on the ground or other movable object or a UAV hovering above the ground. In addition, because the intermediate result of the visual odometry (VO) algorithm of the existing movable platform generates the optical flow vectors of the target feature points required by the obstacle avoidance method, the intermediate result of the existing VO algorithm may be directly obtained to detect the moving object. Thus, the amount of calculation is effectively reduced, the efficiency of the obstacle avoidance detection is increased, and the real-time performance of the obstacle avoidance detection is further improved.

The present disclosure also provides an obstacle avoidance device. FIG. 5 is a structural block diagram of an obstacle avoidance device according to an example embodiment of the present disclosure. As shown in FIG. 5, the obstacle avoidance device 10 is disposed at a movable platform 20. The obstacle voidance device 10 includes a processor 11 and a photographing device 21. The processor 11 is communicatively coupled with the photographing device 21. The photographing device 21 is configured to photograph a depth image. The processor 11 is configured to obtain a depth image photographed by the photographing device 21, recognize a moving object based on the depth image, determine a moving speed vector of the moving object, determine a region where the moving object may collide with the movable platform 20 based on the moving speed vector of the moving object, and control the movable platform 20 to perform the obstacle avoidance process in the potential collision region.

In some embodiments, the processor 11 is configured to obtain the optical flow vectors of the target feature points in the depth image. The target feature points do not include feature points of stationary objects. The moving object is recognized based on the optical flow vectors of the target feature points.

In some embodiments, the processor 11 is configured to obtain the optical flow vectors of the target feature points in the depth image based on the visual odometry (VO) algorithm.

In some embodiments, the processor 11 is configured to extract the feature points from the depth image photographed by the photographing device 21 mounted at the movable platform 20 based on the pre-set corner point detection algorithm, determine the optical flow vectors of the feature points through tracking relative positions of the feature points of two images frames, and remove the optical flow vectors of the feature points of the stationary objects from the optical flow vectors of the feature points based on the three-dimensional coordinates of the feature points in the world coordinate system in the two image frames, to obtain the optical flow vectors of the target feature points.

In some embodiments, the processor 11 is configured to, based on the relative positions of the feature point in the two image frames, determine a first displacement of a relative position of a feature point on a succeeding image frame relative to the relative position of the feature point in a preceding image frame and a second displacement of the relative position of the feature point in the preceding image frame relative to the relative position of the feature point in the succeeding image frame, and determine the optical flow vectors based on the first displacement or the second displacement if a relationship between the first displacement and the second displacement satisfies a pre-set first priori condition.

In some embodiments, the processor 11 is configured to determine an essential matrix corresponding to the three-dimensional coordinates of the feature points in the world coordinate system in the two image frames based on a pre-set second priori condition, and remove the optical flow vectors of the feature points of the stationary objects from the optical flow vectors of the feature points based on the essential matrix and using the random sampling consensus algorithm, to obtain the optical flow vectors of the target feature points. The second priori condition is a condition relationship between the three-dimensional coordinates of the feature points in the world coordinate system in the two image frames and the essential matrix.

In some embodiments, the processor 11 is configured to determine position and attitude of the photographing device when photographing the two image frames based on the three-dimensional coordinates of the feature points in the world coordinate system in the two image frames, and remove the optical flow vectors of the feature points of the stationary objects from the optical flow vectors of the feature points based on the position and attitude of the photographing device when photographing the two image frames and using the random sampling consensus algorithm, to obtain the optical flow vectors of the target feature points.

In some embodiments, the processor 11 is configured to recognize the moving object based on the optical flow vectors of the target feature points, depth information of the target feature points, and visual information of the target feature points, where the visual information includes color and/or brightness.

In some embodiments, the processor 11 is configured to perform a clustering process on the obtained optical flow vectors of the target feature points to obtain at least one optical flow vector group, and recognize the moving object from the at least one optical flow vector group based on the depth information and the visual information of each of the target feature points. A direction displacement between any optical flow vectors in the same optical flow vector group is smaller than a first pre-set threshold and an amplitude displacement between any optical flow vectors in the same optical flow vector group is smaller than a second pre-set threshold.

In some embodiments, the processor 11 is configured to use a floodfill algorithm to recognize the moving object from the at least one optical flow vector group based on the depth information and the visual information of each of the target feature points.

In some embodiments, the processor 11 is configured to: determine a moving speed vector of the moving object based on the three-dimensional coordinates of the moving object in the world coordinate system in a pre-set number of image frames.

In some embodiments, the processor 11 is configured to determine a moving path of the movable platform based on the moving speed vector of the moving object and the moving speed vector of the movable platform, and determine the region where the moving object may collide with the movable platform based on the moving path of the movable platform.

In some embodiments, the processor 11 is configured to project the moving path onto the depth image to determine the region where the moving object may collide with the movable platform in the depth image, and determine the three-dimensional coordinates of the potential collision region in the world coordinate system based on the depth image.

In some embodiments, the processor 11 is configured to control the movable platform to move in a direction opposite to a current moving direction of the movable platform in the potential collision region.

In some embodiments, the processor 11 is configured to adjust the moving path of the movable platform, such that the movable platform circumvents the potential collision region.

In some embodiments, the processor 11 is configured to control the movable platform to stop moving for a pre-set time period to avoid the moving object.

In some embodiments, the photographing device 21 includes at least one camera.

In the embodiments of the present disclosure, the obstacle avoidance device performs the obstacle avoidance method. The operation principle and beneficial effects of the obstacle avoidance device are same as or similar to those of the embodiments of the obstacle avoidance method and will not be repeated here.

The present disclosure also provides a movable platform. The movable platform includes a body, a power system mounted at the body for supplying power to the movable platform, and the disclosed obstacle avoidance device. The movable platform may be any of an unmanned aerial vehicle, an automobile, VR glasses, and AR glasses.

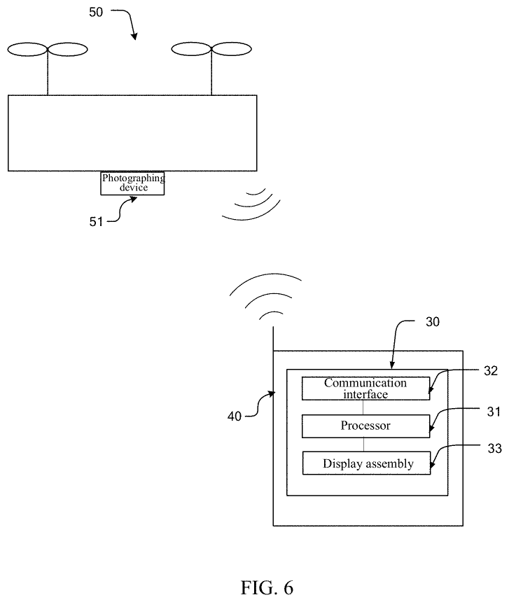

The present disclosure provides another obstacle avoidance device. FIG. 6 is a structural block diagram of another obstacle avoidance device according to an example embodiment of the present disclosure. As shown in FIG. 6, the obstacle avoidance device 30 is disposed at a ground terminal 40. The obstacle avoidance device 30 includes a processor 31 and a communication interface 32. The processor 31 is communicatively coupled with the communication interface 32. The communication interface 32 is configured to obtain a depth image photographed by a photographing device 51 mounted at a movable platform 50. The processor 31 is configured to recognize a moving object based on the depth image, determine a moving speed vector of the moving object, determine a region where the moving object may collide with the movable platform based on the moving speed vector of the moving object, and control the movable platform to perform the obstacle avoidance process in the potential collision region.

In some embodiments, the processor 31 is configured to obtain the optical flow vectors of the target feature points in the depth image. The target feature points do not include feature points of stationary objects. The moving object is recognized based on the optical flow vectors of the target feature points.

In some embodiments, the processor 31 is configured to obtain the optical flow vectors of the target feature points in the depth image based on the visual odometry (VO) algorithm.

In some embodiments, the processor 31 is configured to extract the feature points from the depth image photographed by the photographing device mounted at the movable platform based on the pre-set corner point detection algorithm, determine the optical flow vectors of the feature points through tracking relative positions of the feature points of two images frames, and remove the optical flow vectors of the feature points of the stationary objects from the optical flow vectors of the feature points based on the three-dimensional coordinates of the feature points in the world coordinate system in the two image frames, to obtain the optical flow vectors of the target feature points.

In some embodiments, the processor 31 is configured to: based on the relative positions of the feature point in the two image frames, determine a first displacement of a relative position of a feature point in a succeeding image frame relative to the relative position of the feature point in a preceding image frame and a second displacement of the relative position of the feature point in the preceding image frame relative to the relative position of the feature point in the succeeding image frame, and determine the optical flow vectors based on the first displacement or the second displacement if a relationship between the first displacement and the second displacement satisfies a pre-set first priori condition.

In some embodiments, the processor 31 is configured to: determine an essential matrix corresponding to the three-dimensional coordinates of the feature points in the world coordinate system in the two image frames based on a pre-set second priori condition, and remove the optical flow vectors of the feature points on the stationary objects from the optical flow vectors of the feature points based on the essential matrix and using the random sampling consensus algorithm, to obtain the optical flow vectors of the target feature points. The second priori condition is a condition relationship between the three-dimensional coordinates of the feature points in the world coordinate system in the two image frames and the essential matrix.

In some embodiments, the processor 31 is configured to: determine position and attitude of the photographing device when photographing the two image frames based on the three-dimensional coordinates of the feature points in the world coordinate system in the two image frames, and remove the optical flow vectors of the feature points on the stationary objects from the optical flow vectors of the feature points based on the position and attitude of the photographing device when photographing the two image frames and using the random sampling consensus algorithm, to obtain the optical flow vectors of the target feature points.

In some embodiments, the processor 31 is configured to: recognize the moving object based on the optical flow vectors of the target feature points, depth information of the target feature points, and visual information of the target feature points, where the visual information includes color and/or brightness.

In some embodiments, the processor 31 is configured to: perform a clustering process on the obtained optical flow vectors of the target feature points to obtain at least one optical flow vector group, and recognize the moving object from the at least one optical flow vector group based on the depth information and the visual information of each of the target feature points. A direction displacement between any optical flow vectors in the same optical flow vector group is smaller than a first pre-set threshold and an amplitude displacement between any optical flow vectors in the same optical flow vector group is smaller than a second pre-set threshold.

In some embodiments, the processor 31 is configured to: use a floodfill algorithm to recognize the moving object from the at least one optical flow vector group based on the depth information and the visual information of each of the target feature points.

In some embodiments, the processor 31 is configured to: determine a moving speed vector of the moving object based on the three-dimensional coordinates of the moving object in the world coordinate system in a pre-set number of image frames.

In some embodiments, the processor 31 is configured to: determine a moving path of the movable platform based on the moving speed vector of the moving object and the moving speed vector of the movable platform, and determine the region where the moving object may collide with the movable platform based on the moving path of the movable platform.

In some embodiments, the processor 31 is configured to: project the moving path onto the depth image to determine the region where the moving object may collide with the movable platform in the depth image, and determine the three-dimensional coordinates of the potential collision region in the world coordinate system based on the depth image.

In some embodiments, the obstacle avoidance device further includes a display assembly 33. The display assembly 33 is communicatively coupled with the processor 31. The display assembly 33 is configured to display the moving path of the movable platform.

In some embodiments, the display assembly 33 is configured to display the depth image and mark the potential collision region in the depth image.

In some embodiments, the processor 31 is configured to: control the movable platform to move in a direction opposite to a current moving direction of the movable platform in the potential collision region.

In some embodiments, the processor 31 is configured to: adjust the moving path of the movable platform, such that the movable platform circumvents the potential collision region.

In some embodiments, the processor 31 is configured to: control the movable platform to stop moving for a pre-set time period to avoid the moving object.

In some embodiments, the photographing device includes at least one camera.

In the embodiments of the present disclosure, the obstacle avoidance device performs the obstacle avoidance method. The operation principle and beneficial effects of the obstacle avoidance device are same as or similar to those of the embodiments of the obstacle avoidance method and will not be repeated here.

In the embodiments of the present disclosure, the disclosed device and method may be implemented in other manners. For example, the described device embodiments are intended to be illustrative. For example, division of units is merely a logic function division. In actual implementations, the units may be divided differently. For example, a plurality of units or components may be combined or integrated into another system, and certain features may be omitted or not implemented. Further, the displayed or discussed mutual coupling or direct coupling or communicative coupling may be indirect coupling or communicative coupling through certain interfaces, devices or units, and may be electrical, mechanical, or in other form.

The units described as separate parts may or may not be physically separated. The parts displayed as units may or may not be physical units, that is, may not be located in one place, and may be distributed in a plurality of network units. Some or all modules may be selected according to actual requirements to achieve the objectives of the technical solution of the present disclosure.

In addition, the functional units in the embodiments of the present disclosure may be integrated into one processing module, may be distributed to a plurality of physically separate units, or may have two or more units integrated into one module. The integrated modules may be implemented in hardware or in hardware plus software function modules.

The integrated unit implemented in software function units may be stored in a computer-readable storage medium. The software function units stored in the storage medium includes a plurality of instructions to cause a computer (a personal computer, a server, or a network device) or a processor to perform some or all processes described in embodiments of the present disclosure. The storage medium includes a USB disk, a portable hard drive, a read-only memory (ROM), a random-access memory (RAM), a magnetic disk, an optical disk, and any other medium that can store program code.

Those skilled in the art may understand that for the convenience and brevity of the description, the above described function module division is intended to be illustrative. In practical applications, the functions may be distributed to different function modules for implementation. That is, the internal structure of the device may be divided into different function modules to achieve all or some function s described above. For the detail of the operation principle of the device, reference may be made to the corresponding process in the foregoing method embodiments, and details are not described herein again.

Various embodiments of the present disclosure are merely used to illustrate the technical solution of the present disclosure, but the scope of the present disclosure is not limited thereto. Although the present disclosure has been described in detail with reference to the foregoing embodiments, those skilled in the art should understand that the technical solution described in the foregoing embodiments can still be modified or some or all technical features can be equivalently replaced. Without departing from the spirit and principles of the present disclosure, any modifications, equivalent substitutions, and improvements, etc., shall fall within the scope of the present disclosure. The scope of the invention should be determined by the appended claims.

What is claimed is:

1. An obstacle avoidance method comprising:
obtaining a depth image photographed by a photographing device mounted at a movable platform;
recognizing, based on the depth image, a moving object;
determining a moving speed vector of the moving object;
determining, based on the moving speed vector of the moving object, a potential collision region where the moving object is likely to collide with the movable platform; and
controlling the movable platform to perform an obstacle avoidance process in the potential collision region.

2. The method of claim 1, wherein recognizing the moving object based on the depth image includes:
obtaining optical flow vectors of target feature points in the depth image, the target feature points not being on a stationary object; and
recognizing the moving object based on the optical flow vectors of the target feature points.

3. The method of claim 2, wherein obtaining the optical flow vectors of the target feature points in the depth image includes obtaining the optical flow vectors of the target feature points based on a visual odometry (VO) algorithm.

4. The method of claim 3, wherein obtaining the optical flow vectors of the target feature points based on the VO algorithm includes:
extracting feature points from the depth image based on a pre-set corner point detection algorithm;
determining optical flow vectors of the feature points by tracking relative positions of the feature points in two image frames; and
removing, based on three-dimensional coordinates of the feature points in a world coordinate system in the two image frames, the optical flow vectors of the feature points on the stationary object from the optical flow vectors of the feature points to obtain the optical flow vectors of the target feature points.

5. The method of claim 4, wherein determining the optical flow vectors of the feature points by tracking the relative positions of the feature points in the two image frames includes, for one feature point of the feature points:
determining, based on the relative positions of the one feature point in the two image frames:
a first displacement of the relative position of the one feature point in a succeeding one of the two image frames relative to the relative position of the one feature point in a preceding one of the two image frames, and
a second displacement of the relative position of the one feature point in the preceding one of the two image frames relative to the relative position of the one feature point in the succeeding one of the two image frames; and
determining the optical flow vector of the one feature point based on the first displacement or the second displacement in response to a relationship between the first displacement and the second displacement satisfies a pre-set priori condition.

6. The method of claim 4, wherein removing the optical flow vectors of the feature points on the stationary objects to obtain the optical flow vectors of the target feature points includes:
determining an essential matrix corresponding to the three-dimensional coordinates of the feature points in the world coordinate system in the two image frames based on a pre-set priori condition, the priori condition including a condition relationship between the three-dimensional coordinates of the feature points in the world coordinate system in the two image frames and the essential matrix; and
removing the optical flow vectors of the feature points on the stationary objects from the optical flow vectors of the feature points based on the essential matrix and using a random sampling consensus algorithm, to obtain the optical flow vectors of the target feature points.

7. The method of claim 4, wherein removing the optical flow vectors of the feature points on the stationary objects to obtain the optical flow vectors of the target feature points includes:
determining position and attitude of the photographing device at a time of photographing the two image frames based on the three-dimensional coordinates of the feature points in the world coordinate system in the two image frames; and
removing the optical flow vectors of the feature points on the stationary objects from the optical flow vectors of the feature points based on the position and attitude of the photographing device at the time of photographing the two image frames and using a random sampling consensus algorithm, to obtain the optical flow vectors of the target feature points.

8. The method of claim 2, wherein recognizing the moving object includes recognizing the moving object based on the optical flow vectors of the target feature points, depth information of the target feature points, and visual information of the target feature points, the visual information including at least one of color or brightness.

9. The method of claim 8, wherein recognizing the moving object includes:
performing a clustering process on the optical flow vectors of the target feature points to obtain an optical flow vector group, a direction displacement between any optical flow vectors in the optical flow vector group being smaller than a direction threshold, and an amplitude displacement between any optical flow vectors in the optical flow vector group being smaller than an amplitude threshold; and
recognizing the moving object from the optical flow vector group based on the depth information and the visual information of each of the target feature points.

10. The method of claim 9, wherein recognizing the moving object from the optical flow vector group includes recognizing the moving object from the optical flow vector group using a floodfill algorithm based on the depth information and the visual information of each of the target feature points.

11. The method of claim 1, wherein determining the moving speed vector of the moving object includes determining the moving speed vector of the moving object based on three-dimensional coordinates of the moving object in a world coordinate system in a pre-set number of image frames.

12. The method of claim 1, wherein determining the potential collision region includes:
determining a moving path of the movable platform based on the moving speed vector of the moving object and a moving speed vector of the movable platform; and
determining the potential collision region based on the moving path of the movable platform.

13. The method of claim 12, wherein determining the potential collision region includes:
projecting the moving path onto the depth image to determine the potential collision region in the depth image; and
determining three-dimensional coordinates of the potential collision region in the world coordinate system based on the depth image.

14. The method of claim 12, further comprising:
displaying the moving path of the movable platform.

15. The method of claim 13, further comprising:
displaying the depth image; and
marking the potential collision region in the depth image.

16. The method of claim 1, wherein controlling the movable platform to perform the obstacle avoidance process in the potential collision region includes controlling the movable platform to move in a direction opposite to a current moving direction of the movable platform in the potential collision region.

17. The method of claim 1, wherein controlling the movable platform to perform the obstacle avoidance process in the potential collision region includes adjusting a moving path of the movable platform to circumvent the potential collision region.

18. The method of claim 1, wherein controlling the movable platform to perform the obstacle avoidance process in the potential collision region includes controlling the movable platform to stop moving for a pre-set time period to avoid the moving object.

19. The method of claim 1, wherein the photographing device includes at least one camera.
